(19) United States
(12) Patent Application Publication
(10) Pub. No.: US 2010/0138854 A1
(43) Pub. Date: Jun. 3, 2010

(54) METHOD AND SYSTEM FOR CONTROLLING RESTRICTION ON VIEWING MULTIMEDIA CONTENTS

(75) Inventors: Hyun Jin LEE, Daejeon (KR); Jae Cheol SIM, Daejeon (KR); Kee Seong CHO, Daejeon (KR); Bong Tae KIM, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/609,268

(22) Filed: Oct. 30, 2009

(30) Foreign Application Priority Data
Dec. 2, 2008 (KR) 10-2008-0121394
Apr. 27, 2009 (KR) 10-2009-0036628

(51) Int. Cl. H04N 7/16

(52) U.S. Cl. 725/25

(57) ABSTRACT

There are provided a method and a system for controlling restriction on viewing multimedia contents. In the control of viewing multimedia contents through a terminal, contents transmitted to the terminal are restricted on a network according to a predetermined restriction condition to provide contents based on the user of the terminal. When it is required to change the restriction condition, the restriction condition can be remotely set and changed using a network for a specific user. Accordingly, restriction on viewing contents according to the user can be effectively controlled and the restriction condition can be effectively administrated to provide additional services.

### CROSS-REFERENCE TO RELATED APPLICATION

This application claims the benefit of Korean Application No. 10-2008-0121394, filed on Dec. 2, 2008 and Korean Application No. 10-2009-0036628 filed on Apr. 27, 2009 in the Korean Intellectual Property Office, the disclosure of which is incorporated herein by reference.

### BACKGROUND OF THE INVENTION

### 1. Field of the Invention

The present invention relates to a method and a system for controlling restriction on viewing multimedia contents and, more particularly, to a method and a system for controlling restriction on viewing multimedia contents, which set a condition of restriction on viewing multimedia contents by using a network and restrict a user from viewing multimedia contents based on the condition of restriction on viewing multimedia contents.

2. Discussion of the Related Art

As the number of multimedia contents services such as cable broadcast, satellite broadcast and digital multimedia broadcast (DMB) as well as sky-wave broadcast increases, users are provided with a variety of contents.

When it is required to restrict a user from viewing multimedia contents, a function of restricting viewing of the multimedia contents is implemented in a set top box because multimedia contents are provided in such a manner that a head end transmits the multimedia contents and the set top box receives the multimedia contents.

In order to control restriction on viewing multimedia contents for a specific user, however, it is required to generate an account for the user, input restriction conditions such as age and time allowed to view the multimedia contents to the set top box, perform user authentication when the user turns on the set top box and determine whether to play multimedia contents selected by the user according to the restriction conditions when the user selects the multimedia contents.

There is provided a method of restricting viewing multimedia contents, which stores information on restriction conditions in a set top box, extracts information on restriction from a received broadcasting program and compares the extracted information with the stored information.

Furthermore, there is provided a method of setting a viewer' s account and conditions of restriction on viewing multimedia contents online through a network. However, this method has a problem that a set top box must have a server such as a web server or must be connected to the server in order to remotely change the restriction conditions.

The aforementioned restricting methods are inconvenient to change or administrate conditions of restriction on viewing multimedia contents, and thus restriction on viewing multimedia is not effectively achieved and users indiscreetly view multimedia contents in many cases.

Accordingly, a method capable of controlling restriction on viewing multimedia contents more effectively is required.

### SUMMARY OF THE INVENTION

It is an object of the present invention to provide a method and a system for controlling restriction on viewing multimedia contents, which restrict multimedia contents transmitted to a terminal on a network according to a set condition of restriction on viewing multimedia contents to effectively restrict a user of the terminal from viewing the multimedia contents and easily manage the condition of restriction on viewing multimedia contents to provide additional services.

According to an aspect of the present invention, there is provided a method for controlling restriction on viewing multimedia contents, the method comprising determining whether or not a user of a terminal is allowed to watch a predetermined channel or contents based on a condition of restriction on viewing multimedia contents for the terminal or the user of the terminal when a request for setting a session for the predetermined channel or contents is received from the user; connecting the terminal to a media server that provides the channel or contents such that the contents or contents corresponding to the channel are provided to the terminal when the user of the terminal meets the condition of restriction on viewing multimedia contents and thus the user is allowed to watch the channel or contents; and rejecting the request for setting the session for the predetermined channel or contents, received from the terminal, when the user of the terminal does not meet the condition of restriction on viewing multimedia contents and thus the user is not allowed to watch the channel or contents.

According to another aspect of the present invention, there is provided a system for controlling restriction on viewing multimedia contents, the system comprising a database storing a condition of restriction on viewing multimedia contents for a terminal or the user of the terminal; a media server providing multimedia contents through a predetermined channel; and a call control server performing user authentication on the terminal, determining whether the user of the terminal is allowed to watch a predetermined channel or contents based on the condition of restriction on viewing multimedia contents at the request of the terminal and connecting the terminal to the media server such that contents corresponding to the channel or the contents are provided to the terminal when it is determined that the user of the terminal is allowed to watch the channel or contents.

According to the present invention, the method and system for controlling restriction on viewing multimedia contents previously set a condition of restriction on viewing contents in a network and restrict contents provided to a terminal on the network based on the restriction condition. Accordingly, a user can use designated contents and restricted contents can be effectively blocked, and thus effective restriction on viewing contents can be achieved. Furthermore, the restriction condition can be remotely changed by an administrator, and thus centralized management of information on restriction can be performed and the restriction condition can be easily changed to result in effective administration of multimedia contents provided to the terminal.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a configuration of a system for controlling restriction on viewing multimedia contents according to an embodiment of the present invention;

FIG. 2 illustrates data flow in the system for controlling restriction on viewing multimedia contents illustrated in FIG. 1;

FIG. 3 is a flowchart illustrating operations of a method for controlling restriction on viewing multimedia contents according to an embodiment of the present invention;

FIG. 4 illustrates data flow of an operation of remotely acknowledging or changing a condition of restriction on viewing multimedia contents in the system for controlling restriction on viewing multimedia contents illustrated in FIG. 1; and

FIG. 5 is a flowchart illustrating an operation of changing or acknowledging a condition of restriction on viewing multimedia contents according to restriction on viewing multimedia contents in accordance with an embodiment of the present invention.

### DETAILED DESCRIPTION OF THE PREFERRED EMBODIMENTS

Hereinafter, the present invention will be described below with reference to the accompanying drawings.

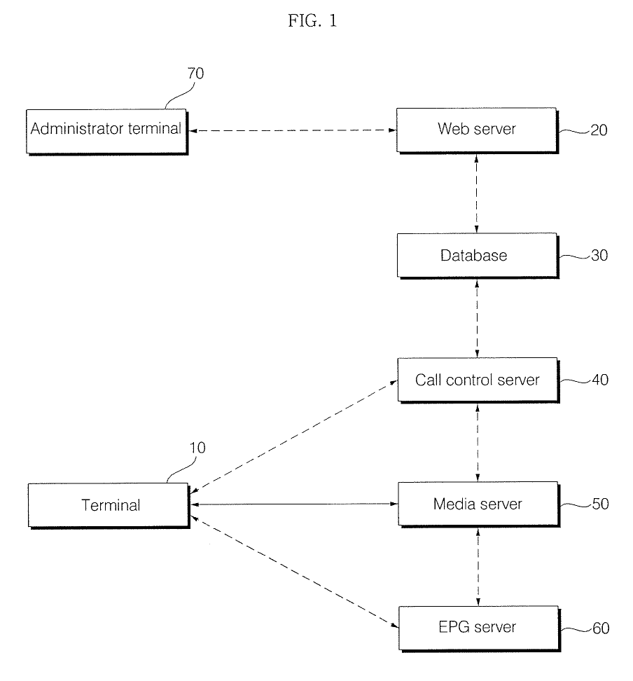

FIG. 1 illustrates a configuration of a system for controlling restriction on viewing multimedia contents according to an embodiment of the present invention.

Referring to FIG. 1, the system for controlling restriction on viewing multimedia contents according to an embodiment of the present invention includes a terminal 10 receiving and playing multimedia contents, at least one media server 50 providing multimedia contents, an electronic program guide (EPG) server 60 providing a program guide with respect to multimedia contents that can be received by the terminal 10, and a call control server 40 controlling connection of the terminal 10 such that the terminal 10 can receive multimedia contents.

In addition, the system includes a database 30 storing conditions of restriction on viewing multimedia contents (referred to as restriction conditions hereinafter), a web server 20 receiving a restriction condition from the terminal 10 or a user, storing the restriction condition in the database 30 and administrating the stored restriction condition, and an administrator terminal 70 connected to the web server 20 to receive data of the restriction condition.

Though the system for controlling restriction on viewing multimedia contents is applied to session initiation protocol (SIP) based next generation network (NGN) environments in the current embodiment, it is not limited thereto and can be applied to other network environments which satisfy conditions according to the present invention in using networks and providing multimedia contents services.

The terminal 10 includes a reproducing unit, an output unit, a storage unit and a communication unit, which can receive, reproduce and display multimedia contents. For instance, a display including a set top box, a computer, a cellular phone or a handheld terminal such as PDA and PDP may be used as the terminal 10.

The terminal 10 is connected to the call control server 40 to request the call control server 40 to perform user authentication and performs an initialization operation for receiving multimedia contents when power is applied to the terminal 10 or a user of the terminal is changed.

When the initialization operation is performed, the terminal 10 receives a program guide with respect to multimedia contents allowable for the user of the terminal from the EPG server 60 and outputs the program guide. When the user selects a channel or contents, the terminal 10 requests the call control server 40 to set a multimedia session such that the terminal 10 can receive the channel or contents.

The terminal 10 is connected to the media server 50 which possesses the selected channel or contents according to a response of the call control server 40, receives the corresponding multimedia contents through the set multimedia session and outputs the received multimedia contents through the output unit included therein.

When the call control server 40 rejects setting of the multimedia session according to a predetermined restriction condition, the terminal 10 outputs a message which informs the user of restriction on viewing multimedia contents and displays the program guide again such that the user selects another channel or contents.

The administrator terminal 70 is connected to the web server 20 based on data input according to an administrator's operation and previously sets a restriction condition for receiving multimedia contents. Here, the administrator terminal 70 is a device connectable to a network and a cellular phone, PDA or Netbook can be used as the administrator terminal 70.

The administrator can add or change a restriction condition for a specific user through the administrator terminal 70 in any place irrespective of the location of the terminal 10 receiving multimedia contents. Furthermore, when the call control server 40 requests the administrator to remotely acknowledge a restriction condition, the administrator can acknowledge or reject the request if required.

The web server 20 performs authentication on a connected user to confirm whether the connected user have the authority to set restriction on viewing multimedia contents, sets input data as a restriction condition and stores the data in the database 30. Here, the restriction condition can be changed and administrated by the user having the authority, that is, a restriction service administrator or home administrator.

That is, general viewers can watch or not multimedia contents according to restrictions condition set by the administrator.

The database 30 stores restriction conditions registered by the web server 20. The restriction conditions include a reference value with respect to at least one of age, time allowed to view multimedia contents, allowable channels, allowable genres, time allowed for each channel and time allowed for each genre. A specific restriction conditions can be set for a specific terminal or user.

The EPG server 60 receives channel information and program information from at least one media server 50 and provides EPG to the terminal 10. The EPG corresponds to a channel selection guide that classifies a plurality of multimedia contents, which can be provided to the terminal 10, by channels and time zones and can be aligned based on one of channel, time, multimedia contents type and genre.

The EPG server 60 is periodically connected to the media server 50, receives contents and channel information to update EPG and provides the updated EPG to the terminal 10.

When the terminal 10 is operated, the call control server 40 performs user authentication for confirming whether the terminal corresponds to a registered user capable of using a normal service and carries out initialization for connecting the terminal 10 to the media server 50 and transmitting multimedia contents.

When the terminal 10 requests the call control server 40 to set a multimedia session for receiving multimedia contents, the call control server 40 connects the terminal 10 to the media server 50 having the corresponding multimedia contents based on a restriction condition with respect to the multimedia contents.

The call control server 40 performs authentication with user account information and a password of a registered user by using user data of a separate user DB. Furthermore, the call control server 40 stores connection information on the media server 50 having contents or providing a predetermined channel service, requests the media server 50 to set a multimedia session and connects the media server 50 with the terminal 10.

Here, the call control server 40 performs user authentication on the terminal 10, and then calls a restriction condition for the user of the terminal 10 from the database 30. If the terminal 10 requests the call control server 40 to set a multimedia session for a channel or multimedia contents, the call control server 40 determines whether the user is allowed to view the channel or multimedia contents based on the restriction condition.

The call control server 40 rejects setting of the multimedia session when it is determined that the user is not allowed to view the channel or contents according to the restriction condition. When it is determined that the user is allowed to view the channel or contents, the call control server 40 requests the media server 50 providing the channel or multimedia contents to set the multimedia session, informs the terminal 10 of completion of setting of the multimedia session according to the response of the media server 50 to set the session between the terminal 10 and the media server 50 such that the multimedia contents are provided to the terminal 10.

In addition, the call control server 40 may request the administrator terminal 70 corresponding to an address of a registered administrator to perform remote acknowledgement without rejecting setting of the multimedia session even through the user is not allowed to view the channel or multimedia contents. The call control server 40 can reject setting of the multimedia session or request the media server 40 to set the multimedia session according to the result of remote acknowledgement. The call control server 40 determines that remote acknowledgement is rejected if there is no response from the administration terminal 50 within a predetermined time when the call control server 40 requests the administrator terminal 70 to perform remote acknowledgement and rejects setting of the multimedia session.

The call control server 40 may transmit an information message representing the cause of rejection to the terminal 10 based on the restriction condition when rejecting setting of the multimedia session.

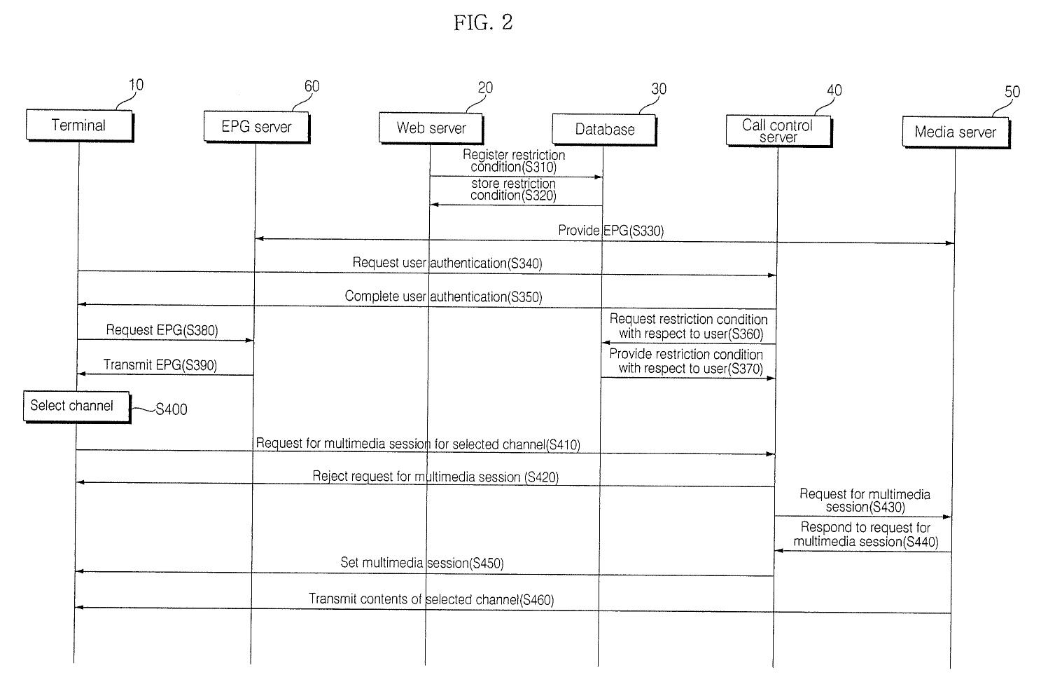

FIG. 2 illustrates data flow in the system for controlling restriction on viewing multimedia contents illustrated in FIG. 1.

Referring to FIG. 2, it is possible to set multimedia contents allowable for the terminal 10 or terminal user and multimedia contents unallowable for the terminal 10 or terminal user.

A user having the authority to set restriction on viewing multimedia contents, that is, a home administrator or a restriction service administrator can access the web server 20 to set a restriction condition for the terminal 1.0 or a specific user. That is, the administrator can access the web server 20 through the administrator terminal 70 such as a computer connected to a network, a handheld terminal or Netbook, be authenticated, and then register or change the restriction condition.

The web server 20 registers input data as a restriction condition and stores the data in the database 30 in steps S310 and S320. Here, the web server 20 may determine whether the user connected thereto is an administrator having the authority to set a restriction condition.

The restriction condition may include at least one of age allowed for a predetermined channel or contents, time allowed to view the predetermined channel or contents, allowable channels, allowable genres, time allowed for each channel and time allowed for each genre.

The EPG server 60 periodically requests at least one media server 50 to provide EPG with respect to a channel or contents and receives the EPG. At the request of the EPG server 60 or in response to a channel or content variation, the media server 50 transmits information associated with the request or variation to the EPG server 60 in step S330.

When the terminal 10 is turned on and operated or the user of the terminal 10 is changed, the terminal 10 requests the call control server 40 to perform user authentication in step S340. Here, the terminal 10 receives a user account and password from the user through a graphic user interface and transmits the user account and password to the call control server 40. The call control server 40 performs user authentication by using the received user account and password and transmits the user authentication result to the terminal 10 in step S350.

After performing user authentication on the terminal 10, the call control server 40 requests the database 30 to provide the restriction condition with respect to the user by using the received user account and receives the restriction condition in steps S360 and S370.

The terminal 10 requests the EPG server 60 to transmit EPG in step S380 and receives the EPG including information on channels or contents and program information from the EPG server 60 in step S390. The terminal 10 periodically receives EPG from the EPG server and updates the EPG.

The terminal 10 displays the EPG and, when the user selects one of channels or contents in the EPG in step S400, requests the call control server 40 to set a multimedia session in order to view the selected channel or contents in step S410.

The call control server 40 determines whether the selected channel or contents satisfies the restriction condition at the request of the terminal 10 for the multimedia session.

The call control server 40 rejects the request of the terminal 10 for the multimedia session when the user is not allowed to view the selected channel or contents in step S420. The call control server 40 requests the media server 50 having the selected channel or contents to set the multimedia session when the user is allowed to view the selected channel or contents in step S430. The media server 50 transmits a response message representing setting of the multimedia session to the call control server 40 in step S440. The call control server 40 transmits a response message representing completion of the multimedia session to the terminal 10 in step S450.

Accordingly, the multimedia session for transmitting multimedia contents is set between the terminal 10 and the media server 50 and the multimedia contents are transmitted from the media sever 50 to the terminal 10 in step S460. Then, the terminal 10 reproduces the received multimedia contents.

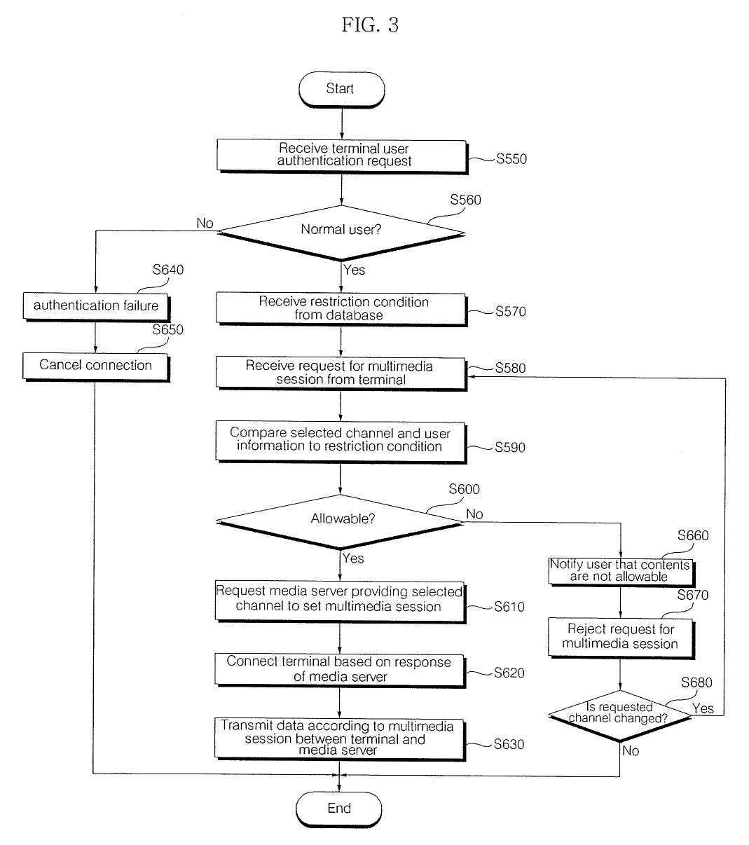

FIG. 3 is a flowchart illustrating operations of a method for controlling restriction on viewing multimedia contents according to an embodiment of the present invention.

As described above, when a user of a terminal requests contents, a network determines whether the requested contents are provided to the terminal by determining whether the user is allowed to view the requested contents based on a predetermined restriction condition. The restriction condition is registered or changed through the web server 20 and stored in the database 30, and thus the administrator can set or change the restriction condition by using the administrator terminal 70 through the web server 20 irrespective of the location of the administrator or the location of the terminal 10.

Operations of determining whether contents are provided and controlling restriction on viewing multimedia contents according to setting of a multimedia session for a terminal will now be explained with reference to FIG. 3.

Referring to FIG. 3, when the terminal 10 is operated, the call control server 40 receives a user account and a password from the terminal 10 and performs user authentication based on the user account and password in step 550. Here, the call control server 40 carries out user authentication using user account and password information of registered users based on user data of a separate user DB.

When the user of the terminal 10 is a registered user, the call control server 40 receives a restriction condition with respect to the user from the database 30 in step S570. When the user is not a normal user, that is, when the user is not a registered user, the call control server 40 transmits a message representing a user authentication failure to the terminal 10 in step S640 and cancels connection of the terminal 10 in step S650.

When a request for a multimedia session with respect to a predetermined channel or contents is received from the terminal 10 in step S580, the call control server 40 compares information on the user with the restriction condition for the predetermined channel or contents in step S590 to determine whether the user is allowed to view the channel or contents in step S600.

The restriction condition includes at least one of age, time allowed to view a predetermined channel or contents, allowable channels, allowable genre, time allowed for each channel and time allowed for each genre, and thus the call control server 40 determines whether the user is allowed to view the channel or contents for each item included in the restriction condition.

For instance, if the age allowed to watch a channel or contents selected by the terminal 10 is set to older than fifteen, it is determined that the user can watch the selected channel or contents if he/she is older than fifteen.

When an allowable channel or contents of the channel does not correspond to the age or allowable genre, the call control server 40 determines that the user is not allowed to view the channel or contents. Furthermore, the call control server 40 determines that the user cannot watch the channel or contents after the lapse of the time allowed to watch the channel or contents or the time allowed for each channel even though the user is allowed to view the channel or contents.

The call control server 40 can request the media server 50 to cancel the multimedia session after the lapse of the time allowed to watch the channel or contents or the time allowed for each channel even though the contents are being transmitted to the terminal 10.

The call control server 40 requests the media server 50 providing the selected channel or contents to set the multimedia session for the terminal 10 and connects the terminal 10 to the media server 50 in step S610. Here, the call control server 40 stores connection information on the media servers which have multimedia contents or provide channel services and requests the corresponding media server 50 to set the multimedia session.

When the media server 50 acknowledges setting of the multimedia session, the call control server 40 transmits a response message representing completion of the multimedia session to the terminal 10 such that the terminal 10 is connected to the media server 50 in step S620.

Accordingly, the terminal 10 receives the contents from the media server 50 and reproduces the received contents, and the call control server 40 administrates the set multimedia session in step S630.

When it is determined that the user is not allowed to watch the channel or contents requested by the terminal 10 according to the restriction condition, the call control server 40 transmits a message representing that the channel or contents is not allowable to the terminal 10 in step S660 and rejects the request of the terminal 10 for the multimedia session in step S670.

When a request for a multimedia session for another channel or contents is received from the terminal 10 in step S680 after the request of the terminal 10 for the multimedia session is rejected, the call control server 40 determines whether the requested channel or contents meets the restriction condition and requests the media server to set the multimedia session in steps S610, S620 and S630 or rejects the request for the multimedia session for another channel or contents in steps S660 and S670, as described above.

When the user of the terminal 10 is changed, user authentication is performed, and then the aforementioned operations are carried out in steps S560 through S630 or in steps S560 through S680.

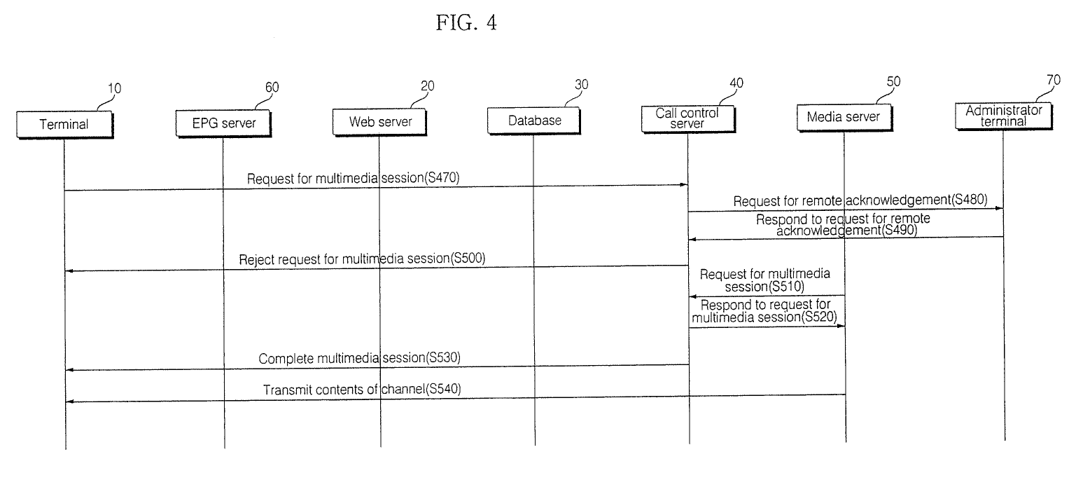

FIG. 4 illustrates data flow of an operation of remotely acknowledging or changing a restriction condition in the system for controlling restriction on viewing multimedia contents illustrated in FIG. 1.

Before the call control server 40 rejects a request of the terminal 10 for a multimedia session for a channel or contents that is not allowed for the terminal user according to the restriction condition with respect to the terminal user, the call control server 40 can request the administrator to perform remote acknowledgement to receive acknowledgement for watching the channel or contents or confirm whether viewing of the selected channel or contents is restricted in real time.

Referring to FIG. 4, when the call control server 40 receives a request for a multimedia session for a predetermined channel or contents from the terminal 10 in step S470, the call control server 40 determines whether the terminal 10 or the user of the terminal 10 is allowed to view the corresponding channel or contents based on the restriction condition set for the user.

The call control server 40 withholds rejection of the request for the multimedia session and requests a registered administrator to perform remote acknowledgement in step S480 when the channel or contents requested by the terminal 10 does not meet the restriction condition, that is, when the channel or contents is not allowable for the user.

Here, the call control server 40 transmits a remote acknowledgement request to an administrator with respect to the user through a mail, a message or the like. The administrator can confirm the mail or message representing the remote acknowledgement request through the administrator terminal 70 and transmit a response message representing acknowledgement or rejection through the administrator terminal 70. When the call control server 40 receives the response to the remote acknowledgement request from the administrator through the administrator terminal 70 in step S490, the call control server 40 sets the multimedia session or rejects the request for the multimedia session according to the received response.

When the administrator rejects the remote acknowledgement request, the call control server 40 rejects the request of the terminal 10 for the multimedia session in step S500.

When the channel or contents requested by the terminal 10 is remotely acknowledged by the administrator although the channel or contents does not meet the restriction condition, the call control server 40 requests the media server 50 providing the channel or contents to set the multimedia session in step S510.

When the call control server 40 receives a response message representing setting of the multimedia session from the media server 50 in step S520, the call control server 40 transmits a response message representing completion of the multimedia session to the terminal 10.

Accordingly, contents corresponding to the channel or the contents are transmitted from the media server 50 to the terminal 10 through the multimedia session set between the terminal 10 and the media server 50 in step S540. The terminal 10 reproduces the received contents.

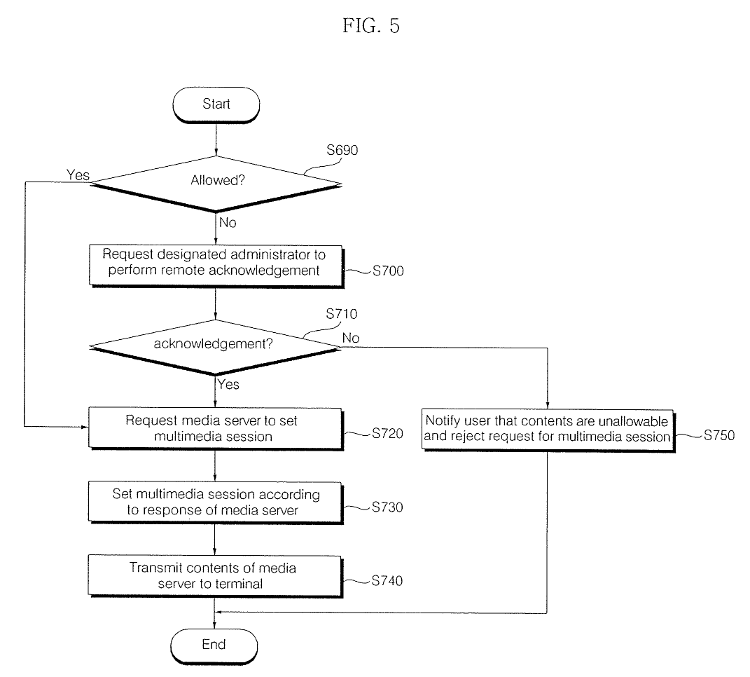

FIG. 5 is a flowchart illustrating an operation of changing or acknowledging a restriction condition according to restriction on viewing multimedia contents in accordance with an embodiment of the present invention.

Referring to FIG. 5, the call control server 40 determines whether the user of the terminal 10 is allowed to watch a channel or contents selected by the terminal 10 based on the restriction condition corresponding to the user, which is stored in the database 30, at the request of the terminal 10 for a multimedia session in step S690.

The call control server 40 determines that the user is allowed to watch the channel or contents when the channel or contents meets all of items included in the restriction condition including at least one of age, time allowed to watch a predetermined channel or contents, allowable channels, allowable genres, time allowed for each channel and time allowed for each genre and determines that the user is not allowed to watch the channel or contents when the channel or contents does not meet any one of the items.

When it is determined that the user is allowed to watch the channel or contents, the call control server 40 requests the media server 50 to set the multimedia session for the terminal 10 to set the multimedia session between the terminal 10 and the media server 50 such that the contents are provided to the terminal 10 in steps S720, S730 and S740, as described above.

When it is determined that the user is not allowed to watch the channel or contents, the call control server 40 rejects the request of the terminal 10 for the multimedia session, as illustrated above with reference to FIG. 3. However, when remote acknowledgement is set, the call control server 40 withholds rejection of the request for the multimedia session and requests the administrator to perform remote acknowledgement through a mail or a message, as described above.

The call control server 40 determines that the remote acknowledgement request is rejected when a response is not received within a predetermined time after the call control server 40 requests the administrator to perform remote acknowledgement.

When the remote acknowledgement request is accepted and the user of the terminal 10 is allowed to watch the channel or contents, the call control server 40 requests the media server 50 providing the channel or contents to set the multimedia session even though the channel or contents does not meet the restriction condition in step S720.

When a response message representing completion of the multimedia session is received from the media server 50, the call control server 40 notifies the terminal 10 that the multimedia session is set in step S730 and connects the terminal 10 to the media server 50 such that the multimedia contents are provided to the terminal 10 in step S740.

When the multimedia session is completed, the terminal 10 receives the contents of the channel or the contents from the media server 50 and reproduces the contents.

When the remote acknowledgement request is rejected or a response to the remote acknowledgement request is not received for a predetermined time, the call control server 40 notifies the terminal 10 that the user is not allowed to view the channel or contents and rejects setting of the multimedia session in step S750.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for controlling restriction on viewing multimedia contents, the method comprising:
determining whether or not a user of a terminal is allowed to watch a predetermined channel or contents based on a condition of restriction on viewing multimedia contents for the terminal or the user of the terminal when a request for setting a session for the predetermined channel or contents is received from the user;
connecting the terminal to a media server that provides the channel or contents such that the contents or contents corresponding to the channel are provided to the terminal when the user of the terminal meets the condition of restriction on viewing multimedia contents and thus the user is allowed to watch the channel or contents; and
rejecting the request for setting the session for the predetermined channel or contents, received from the terminal, when the user of the terminal does not meet the condition of restriction on viewing multimedia contents and thus the user is not allowed to watch the channel or contents.

2. The method of claim 1, wherein the determining of whether or not the user is allowed to watch the predetermined channel or contents comprises determining whether the user of the terminal is allowed to watch the channel or contents based on the condition of restriction on viewing multimedia contents, which includes at least one of age, time allowed to watching contents, allowable channels, allowable genres, time allowed to watch each channel and time allowed to watch each genre with respect to the channel or contents requested by the terminal.

3. The method of claim 2, wherein the determining of whether or not the user is allowed to watch the predetermined channel or contents comprises determining whether the user of the terminal is allowed to watch the channel or contents based on each of the items of the condition of restriction on viewing multimedia contents, determining that the user of the terminal is not allowed to watch the contents if it is determined that the user is not allowed to watch the contents for at least one of the items, and determining that the user of the terminal is allowed to watch the contents if it is determined that the user is allowed to watch the contents for all the items.

4. The method of claim 1, wherein the connecting of the terminal to the media server comprises requesting the media server to set the session for the channel or contents, notifying the terminal of completion of setting of the session according to a response of the media server and relaying setting of the session to enable transmission of contents between the media server and the terminal.

5. The method of claim 1, further comprising transmitting a remote acknowledgement request for permission to watch the channel or contents to a previously registered administrator terminal when it is determined that the user of the terminal is not allowed to watch the channel or contents before rejecting the request for setting the session for the predetermined channel or contents.

6. The method of claim 5, wherein the transmitting of the remote acknowledgement request comprises connecting the terminal to the media server providing the channel or contents such that the contents or the contents corresponding to the channel are provided to the terminal when remote acknowledgement is performed.

7. The method of claim 5, further comprising performing user authentication on the terminal, and then receiving the condition of restriction on viewing multimedia contents with respect to the terminal or the user of the terminal, which is stored in a database registered by an administrator, through a web server.

8. A system for controlling restriction on viewing multimedia contents, the system comprising:
a database storing a condition of restriction on viewing multimedia contents for a terminal or the user of the terminal;
a media server providing multimedia contents through a predetermined channel; and
a call control server performing user authentication on the terminal, determining whether the user of the terminal is allowed to watch a predetermined channel or contents based on the condition of restriction on viewing multimedia contents at the request of the terminal and connecting the terminal to the media server such that contents corresponding to the channel or the contents are provided to the terminal when it is determined that the user of the terminal is allowed to watch the channel or contents.

9. The system of claim 8, wherein the call control server receives the condition of restriction on viewing multimedia contents from the database, determines whether the user of the terminal is allowed to watch the channel or contents requested by the terminal, requests the media server to set a session such that the contents corresponding to the channel or the contents are provided to the terminal when it is determined that the user of the terminal is allowed to watch the channel or contents, and rejects the request of the terminal when it is determined that the user of the terminal is not allowed to watch the channel or contents.

10. The system of claim 9, wherein the call control server determines that the user of the terminal is allowed to watch the predetermined channel or contents if it is determined that the user is allowed to watch the channel or contents for all of items included in the condition of restriction on viewing multimedia contents, determines that the user of the terminal is not allowed to watch the channel or contents if it is determined that the user is not allowed to watch the channel or contents for at least one of the items and rejects the request of the terminal.

11. The system of claim 10, wherein the call control server determines whether the user of the terminal is allowed to watch the channel or contents based on the condition of restriction on viewing multimedia contents, which includes at least one of age, time allowed to watching contents, allowable channels, allowable genres, time allowed to watch each channel and time allowed to watch each genre with respect to the channel or contents requested by the terminal.

12. The system of claim 8, wherein the call control server transmits a remote acknowledgement request for permission to watch the channel or contents to a registered administrator terminal when it is determined that the user of the terminal is not allowed to watch the channel or contents and connects the terminal to the media server such that the contents or the contents corresponding to the channel are provided to the terminal when remote acknowledgement is performed.

13. The system of claim 8, further comprising:
a web server performing a authentication process, which confirms whether a connected user has the authority to set a restriction on viewing multimedia contents, on the connected user, setting input data as the condition of restriction on viewing multimedia contents when an administrator of a service providing restriction on viewing multimedia contents or home administrator having the authority is connected thereto and storing the data in the database.
